(19) United States
(12) Patent Application Publication
(10) Pub. No.: US 2024/0281574 A1
(43) Pub. Date: Aug. 22, 2024

(54) Object Oriented Method of Fatality Probability Determination

(71) Applicant: RAFAEL ADVANCED DEFENSE SYSTEMS LTD., Haifa (IL)

(72) Inventors: Ronen Ingbir, Ramat Gan (IL); Nave Ben-Yakov, Yaad (IL); Mordechai Moty Harmats, Kiryat Haim (IL)

(21) Appl. No.: 18/571,775

(22) PCT Filed: May 10, 2022
(86) PCT No.: PCT/IL2022/050485

§ 371 Date: Dec. 19, 2023

(30) Foreign Application Priority Data
Jun. 27, 2021 (IL) 284418

(51) Int. Cl. G06F 30/20; G06F 111/08

(52) U.S. Cl. CPC G06F 30/20; G06F 2111/08

(57) ABSTRACT

A method for creating a dedicated optimal local grid around a place of interest comprises: a) iteratively updating the local grid size such as to satisfy statistical constraints; and b) discontinuing the iterative process of step (a) when a predefined threshold of said statistical constraint is reached.

### FIELD OF THE INVENTION

This invention relates to a method for calculation of a fatality probability distribution in flight tests, caused by rogue missiles of atypical trajectories, by using falls map from Monte-Carlo simulation runs. The fatality distribution is used for Weapon Danger Area (WDA) determination. The WDA is difficult to map, because its boundary is usually situated in sparse falls regions with limited falls data. This invention presents a method to overcome the problem of fatality probability calculation in sparse falls areas, by iterative grid size optimization and confidence correction approach.

### BACKGROUND OF THE INVENTION

Safety is a major consideration when testing weapons, particularly airborne weapons such as missiles or the like. Since there are obvious limitations to the area that can be allocated for such tests, it is extremely important to be able to realistically predict which areas may be endangered by fragments falling as a result of any such tests. This prediction capability is highly important for the sake of the test plan and the test approval. Similar scenarios might occur under enemy attack situations in which weaponry has to be intercepted in the vicinity of populated areas, and therefore the intercepting point has high risk of causing damage on the ground. All the abovementioned missiles, weapons and other flying objects will also be termed hereinafter “flying object” for the sake of brevity. Also, the terms “fragment” and “debris” will be used interchangeably in the description to follow.

It is therefore crucial to have a reliable prediction tool for the rogue missiles and interception debris trajectories, to effectively map the flying objects falls density, in as many scenarios as possible. This map is usually generated by performing numerous runs of Monte-Carlo simulations for objects with random faults and counting the falls in discrete grid cells. It is challenging to obtain a reliable evaluation of the fatality probability in sparse falls areas, especially in the WDA boundary region, because of the high sensitivity of falls distribution in this area to grid cells size. Furthermore, current methods for determining far tails by extrapolation are unreliable, and no predetermined method exists for doing this accurately since the distribution type is often unknown.

### SUMMARY OF THE INVENTION

In one aspect, the invention relates to a method for creating a dedicated optimal local grid around a place of interest, comprising:
a. Iteratively updating the local grid size such as to satisfy statistical constraints; and
b. Discontinuing the iterative process of step (a) when a predefined threshold of said statistical constraint is reached.

In one embodiment of the invention, the statistical constraints refer to a minimal fatality probability value (FP).

In some cases, the predefined threshold cannot be achieved due to an insufficient number of runs. In these cases, the procedure will involve additional methods to try and converge, for example by increasing the number of runs.

Furthermore, in some cases reaching the predefined threshold is not feasible, which means that the test plan should be changed or even canceled. Alternatively, if the predefined threshold cannot be met, the iterative process is discontinued and restarted using a different predefined threshold.

According to one embodiment of the invention, the input to the local grid size optimization procedure includes falls distribution data from flight test(s) or Monte-Carlo simulation(s). In some embodiments, the statistical constraints include a fatality probability evaluation. In specific embodiments of the invention, the fatality probability evaluation relates to rogue missiles or other flying objects or fragments originating from flying objects.

Typically, the local grid structure is selected from among a rectangular lattice, a circular grid, or a free-shape grid. Embodiments of the invention comprise correcting the number of falls in each grid cell to reach a required confidence level. Other embodiments of the invention comprise computing a tight upper bound of fatality probability for sparse falls areas.

### BRIEF DESCRIPTION OF THE DRAWINGS

FIG. 1 is a flow chart of the process employed in the iterated construction of grid cells to optimize all cells for the falls density that is a basis for calculation of the probability of fatality, according to one embodiment of the invention;

FIG. 2 is an example of an initial fine grid, with cells of equal size and definition of areas of interest (e.g. shaded box representing a building), according to one embodiment of the invention. The purpose of the following steps is to determine whether the area of interest is in or out the WDA;

FIG. 3 shows an example of the first stage of cells merging (see description hereinafter);

FIG. 4 shows a final (illustrative) grid where the cells in areas of interest meet the optimality condition in the area of interest;

FIG. 5 sssss an alternative to the initial fine grid, where a plurality of single cells, each enclosing a single object of interest, is defined;

FIG. 6 illustrates a procedure (see description hereinafter) according to which the cells enclosing the objects of interest are enlarged;

FIG. 7 shows an example of an optimization procedure for a synthetic normal distribution falls map; and

FIG. 8 shows an example of an optimization procedure for an empirical falls map.

### DETAILED DESCRIPTION OF THE INVENTION

In the context of this invention, fatality, herein, generally relates to any damage (direct or indirect) to living beings or infrastructure.

Computing the fatality probability requires knowledge of a ‘falls map’ of rogue missiles, fragments, and debris (i.e., those with anomalous flight paths). When dealing with weapons testing and other preplanned activities involving fragments of debris, this map is usually generated by performing numerous runs of Monte-Carlo simulations of flying objects containing random faults and subsequently counting the falls in discrete grid cells. Typically, a ground impact probability density distribution and directly related fatality probability distribution are generated and mapped.

No analytical distribution function for the falls' density can be assumed in advance in a real-world scenario, especially in sparse fall areas (i.e., where few or even zero flying objects are predicted to fall). Reliably evaluating the fatality probability distribution in sparse falls areas in the WDA boundary region is challenging for the following reasons:
Sensitivity to grid size that is practically a free parameter. It is obvious that squares with zero falls within, cannot be related to zero probability, because of final size of Monte-Carlo batch.
It is unreliable to compute far ‘tails’ by extrapolation of the existing data since the type of distribution is often unknown.

The present invention accounts for sparse falls areas, whereby the grid elements within those areas are iteratively enlarged and recalculated for fatality probability (including correction for confidence level) until some minimum or steady value of fatality probability is reached.

The fatality probability value (FP) computed by this method will be compared to an acceptable fatality level, as set by authorities or safety standards.

The present invention has the advantage of being able to:
1) Possibility to focus on areas of interest, such as settlements, roads, etc.
2) Solve the issue of zero falls regions by ascribing a non-zero probability to every cell through confidence level correction.
3) Set work grid cell sizes that are not dependent on the initial grid size since iterative sampling and confidence level corrections modify the cell size to achieve an optimal size.

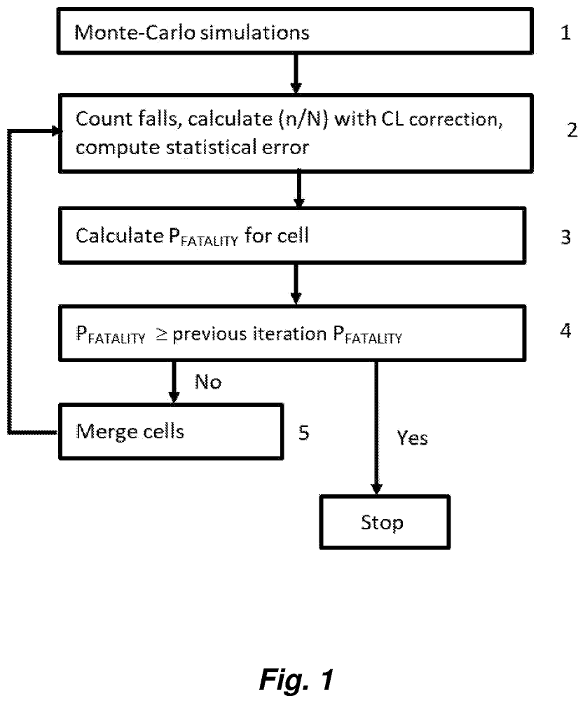

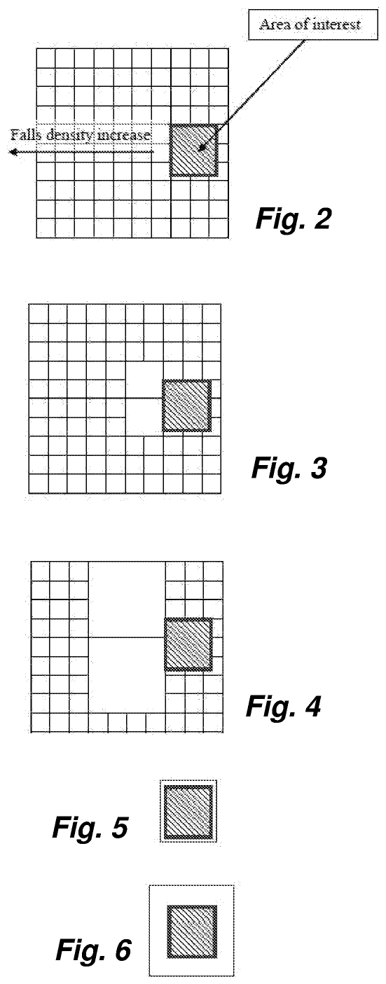

The falls density iterated sampling process operates as follows (see FIG. 1). Numbers in square brackets ‘[ ]’ refer to stages in FIG. 1:
[1] A coordinate system, with grid cells of small initial size, is chosen (see FIG. 2 for an example of starting grid) or alternatively, defining single cells, each enclosing a single object of interest (see FIG. 5). A Monte-Carlo simulation of N runs is carried out (or acquired from a data archive) generating a falls map for rogue missiles and fragments.
[2] The number of falls (n) is counted for each grid cell (i.e., binned) and the (n/N) ratio in each cell is calculated and corrected to (n/N)c for confidence level, according to expressions (2)-(5). The relative statistical error in each cell is computed-err=(n_{C}−n)/n_{C}
[3] The fatality probability is calculated in each cell according to expression (1).
[4] If the fatality probability begins to increase relative to the value of its ancestor or becomes steady, stop. Otherwise go to stage [5].
[5] The cells are enlarged in areas of interest by one of the following methods:
   (1) Total re-gridding
   (2) Enlarging the cells around an object of interest (for single cells option-see stage [1] and the illustration in FIG. 6.)
   (3) Merging the cells inward (to a denser direction) starting at the inner edge of the area of interest-see the illustration in FIGS. 2-4. The resulted falls density in this method is referred to the outer edge of the resulted cells (and not to their centers).

This method of grid enlargement results in an upper bound for the density value.
[6] Go to stage [2].

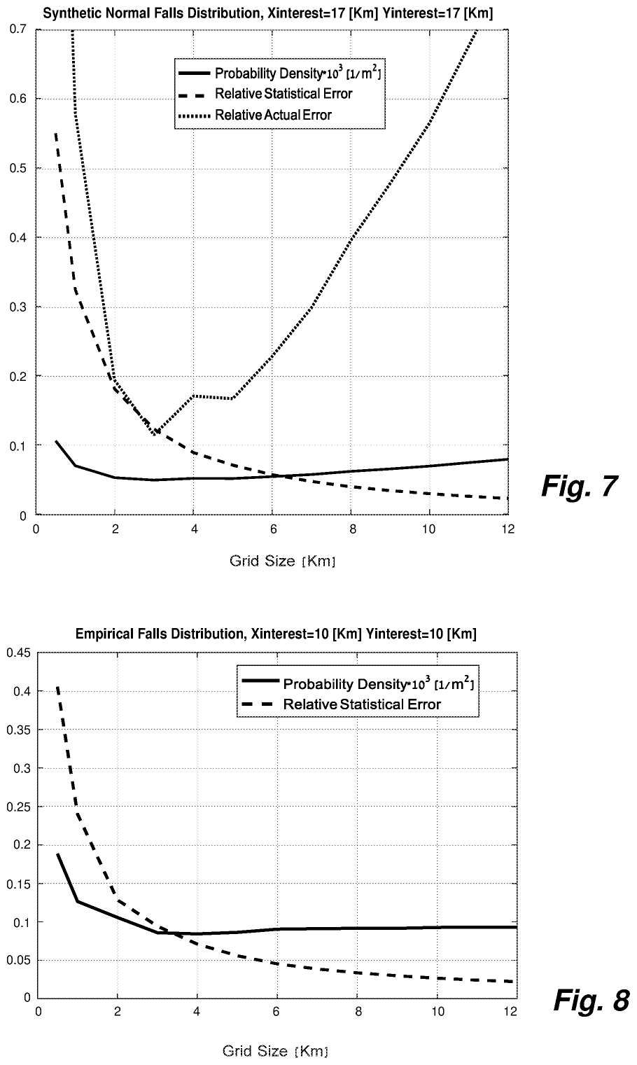

Examples for such optimization procedure for empirical falls map and for synthetic normal distribution falls map are provided in FIGS. 7-8.

The steps of the process according to one embodiment of the invention are as follows:
Location of the objects of interest (e.g., buildings, roads) on falls map;
Setting the basic minimal grid size covering the object area and area around it (or specific geometric grid shape);
The individual probability of fatality at each grid cell is computed by summation of falls in the cells and by subsequently using the following expression:

$$\\ \begin{matrix}{p}_{fatality} = {q}_{fault} \cdot {( \frac{n}{N} )}_{C} \cdot ( \frac{MAE}{{S}_{cell}} ) & ( 1 )\end{matrix}$$

where:
q_{fault}—probability of fault that causes anomalous trajectory
N—number of Monte-Carlo runs
n—number of falls in grid cell
(n/N)_{c}—falls ratio in grid cell, corrected for Confidence Level
S_{cell}—cell area
MAE—mean area of effect (fatality)

The process according to the invention corrects the number of falls in each grid cell for a given Confidence Level parameter. The correction takes into account the fact that the specific Monte-Carlo set that is used in the computation does not cover all possible sets (with different random initial seeds). The correction is done using a Binomial distribution, meaning that an unknown probability parameter of a rogue missile to fall in a specific square is estimated using Bernoulli sampling. The Binomial distribution function (bₙ) and Binomial cumulative function (Bₙ) are expressed as follows:

$$\\ \begin{matrix}{b}_{n} = \frac{N !}{n ! ( N - n ) !} {{p}^{{}_{} n} ( 1 - p )}^{N - n} & ( 2 )\end{matrix}$$

$$\\ \begin{matrix}{B}_{n} = {\sum }_{i = 0}^{n} {b}_{i} & ( 3 )\end{matrix}$$

The falls ratio (n/N), corrected for Confidence Level (C), is defined as:

$$\\ \begin{matrix}p ≡ {( \frac{n}{N} )}_{C} & ( 4 )\end{matrix}$$

p is computed such that, for a given n, N and C it fulfils the following condition:

$$\\ \begin{matrix}{B}_{n} = 1 - C & ( 5 )\end{matrix}$$

The statistically corrected number of falls in each cell is computed straightforwardly as:

$$\\ \begin{matrix}{n}_{c} = p \cdot N & ( 6 )\end{matrix}$$

The confidence level correction is significant for small (n/N) ratios.

For example for (n/N)=0, and a required Confidence Level of 90% (C=0.9)→p=(n/N)_{c}=2.3/N. Explanation: for this case, the expression (5) reduces to (1−p)N=1−C→In(1−p)=In(1−C)/N, and we obtain the final result by using the first (dominant) term in the Taylor expansion of In(1−C). If a lower confidence level is used (e.g. 80%), then the fatality probability will decrease to p=1.6/N.

All the above description and examples have been provided for the purpose of illustration and are not intended to limit the invention in any way.

1. A method for creating a dedicated optimal local grid around a place of interest, comprising:
a. Iteratively updating the local grid size such as to satisfy statistical constraints; and
b. Discontinuing the iterative process of step (a) when a predefined threshold of said statistical constraint is reached.

2. The method according to claim 1, wherein the statistical constraints refer to a minimal fatality probability value (FP).

3. A method according to claim 1, wherein the input to the updating of the local grid size optimization includes falls distribution data from flight test(s) or Monte-Carlo simulation(s).

4. A method according to claim 2, wherein the fatality probability evaluation relates to rogue missiles or other flying objects, or fragments originating from flying objects.

5. A method according to claim 1, wherein the local grid structure is selected from among a rectangular lattice, a circular grid, or a free-shape grid.

6. A method according to claim 3, comprising correcting the number of falls in each grid cell to reach a required confidence level.

7. A method according to claim 2, comprising computing a tight upper bound of fatality probability for sparse falls areas.

8. A method according to claim 3 further comprising steps for:
a. Evaluating the convergence of said statistical constrains;
b. Perform additional MC runs, adding statistics to said distribution data;
c. Using said re-generated distribution data as input to the grid update process.

9. A method according to claim 1, wherein if the predefined threshold cannot be met, the iterative process is discontinued and restarted using a different predefined threshold.
